(19) United States
(12) Patent Application Publication
(10) Pub. No.: US 2022/0351048 A1
(43) Pub. Date: Nov. 3, 2022

(54) System and Method for Organising Big-Data and Workstream Parameters for Digital Transformations

(71) Applicant: Digiworkz Limited, London (GB)

(72) Inventor: Laurence COLLINS, London (GB)

(21) Appl. No.: 17/661,384

(22) Filed: Apr. 29, 2022

(30) Foreign Application Priority Data
Apr. 29, 2021 (GB) 2106168.4

(51) Int. Cl. G06N 5/02; G06F 16/28; G06F 16/2457

(52) U.S. Cl. CPC G06N 5/02; G06F 16/285; G06F 16/24573

(57) ABSTRACT

System and Method for organising big-data and extracting workstream parameters to expedite digital transformations, employing analytics to prompt, promote and predict better answers to complex challenges from cognitively diverse communities thus mitigating digital programme transformation risks using crowds of human-centred thinking, total knowledge sourcing, personalised skills enhancement, augmented problem analysis and immersive team solutioning that is channelled into a group consensus for better decision making, comprising a cloud based hosting and analytical AI platform; performing the following steps to the inputted data: Ingest, Supplement; Cluster, Predict and Output; and for use for use in standard computing environments as well as virtual environments, in online virtual worlds or metaverse.

### FIELD OF THE INVENTION

The present invention relates to computer based system and method for organising big-data and extracting workstream parameters to expedite digital transformations, which system and method employs analytics to prompt, promote and predict better answers to complex challenges from cognitively diverse communities thus mitigating digital programme transformation risks using crowds of human-centred thinking, total knowledge sourcing, personalised skills enhancement, augmented problem analysis and immersive team solutioning that's channelled into a group consensus for better decision making.

### BACKGROUND OF THE INVENTION

Continuous Transformation: We are living in a world where transformation has become the norm—where people and the organisations they work for are charged with continuously re-shaping the ways they work, collaborate and deliver value. We have entered an age of continuous transformation, where change has become the business as usual. Any given FTSE 250 company will currently have numerous transformation programs underway, amidst a plethora of technology implementations, workforce transformation initiatives, change management strategies, new hybrid working practices and policies, tactical initiatives, and the rest. When it comes down to it, sustainable value is driven by how effectively these programs and initiatives are executed, and how quickly people can adopt the changes that drive success. It is a given then, that transformation programs and the underlying drivers of transformation success should be meticulously measured, adapted and optimised to create superior value and gain competitive advantage. So, why is it that 86% of digital transformation programs fail to meet their objectives? Why are so many people subjected to the dark, lonely, disempowering experience of taking part in a failed transformation initiative?

Transformation Problems: Our experience of leading global digital transformation programs across the past 30 years is that there are a recurrent set of challenges that typically need to be overcome, in order to realise the program potential. Problems, and the necessity of innovative solutions are inevitable on a large program. This led us to our key finding—it is not the specific problem to be solved, the magnitude of the change required, or the ambition of the program that tends to be the genuine obstacle—it is the ability of the organisation to collectively solve problems. This is what determines overall program success—the ability to leverage diverse thinking and come up with solutions to scenarios that hadn't been foreseen. The ability to adopt a new technology at pace to accelerate a workstream. The ability to rapidly source and onboard new talent in a seamless manner.

All of these distinct and unique problems require one thing: the ability to solve problems. Collective problem-solving and solutioning ability is the single biggest predictor of transformation success. Yet, it is often poorly developed, unquantifiable and the single biggest cause of lost value. Harvard Business Review finds that in a typical large organisation, only 3-5% of an organisation's employees were producing 20-35% of the overall output, which demonstrates a poor utilisation of knowledge and collective problem-solving across a workforce. By improving the collective ability to solve problems and build solutions, at pace, organisations can improve transformation program outcomes, and gain an advantage.

Collective Intelligence in a Hybrid World: We have found that collective problem-solving is particularly at risk in highly distributed hybrid teams. We have also found that building collective intelligence is a major value opportunity in globally diverse organizations. It is almost as if collective intelligence has become the new battleground of value for organisations seeking to adapt to new hybrid working practices, and continuously transform their organisation. Many leaders believe working in a hybrid world impacts innovation negatively by hindering collaboration and creativity. Emphasising collective intelligence has become even more critical for organizations after the pandemic, as employees started to work from home and became isolated from their teams. However, some companies have proven that with the right tools, culture and approach, employees can brainstorm, generate new ideas, and increase their creativity while working from anywhere. So how do you build an organisation of collective problem-solvers?

The Secret Ingredient: Collective Intelligence: The key to solving problems and building solutions is connected knowledge. Knowledge of the problem, knowledge of potential solutions, knowledge of the latest expertise and management science that applies to the issues, knowledge of what has or hasn't worked before, knowledge of where to look, knowledge of who to ask, knowledge of how to ideate, knowledge of how to deliver. Unfortunately, organisations are brimming full of knowledge, human experience and unawakened potential—but this knowledge is often hard to access at the point of need. Knowledge is lost in silos, knowledge is not connected up across programs, knowledge is out-of-date or unchallenged by the latest thinking.

Knowledge is about far more than a disparate set of communication tools and knowledge management facilities. Knowledge is the fuel that allows connected thinking to accelerate collective problem-solving—yet it is often in scarce supply. Our experience has shown us that transformation programs which have a dedicated focus on knowledge-sharing and collective problem-solving, perform 3× better than those that do not.

This is because they are able to leverage and build the collective intelligence of the group, to come up with faster, better solutions than their counterparts.

It is this collective intelligence, and the ability to translate connected thinking into action, that delivers superior value. But how do you build collective intelligence?

Leveraging Collective Intelligence: Our collective intelligence method and system, named Nexus™, leverages collective intelligence, and drive superior value from transformation programs. Powered by artificial intelligence, and housed in the metaverse, Nexus™ connects people across an organisation to the latest knowledge, ideas and tools that can help them to collectively solve problems—including our client community driven, ever expanding graph of transformation problems that have been posted. We call the challenges and the resultant solutions that are shaped on our technology nodes. These nodes are surfaced to clients to leverage the past experiences and outcomes experienced by other clients that encountered similar challenges and overcame them successful. This ability to interrogate, aggregate and prescribe insights to problems is performed by our AI brain in Nexus called Noda™.

The inventions provides the central environment for all transformation-related problem-solving, knowledge-sharing and solution-building. It also provides individual users with a tailored multi-sensory experience, a sort of “Netflix of Collective Intelligence”. Following successful implementations with several FTSE 100 companies who have used Nexus to build collective intelligence and drive their transformation agenda, Nexus has now been selected for an exclusive partnership with one of the world's leading Metaverse providers, to build a fully immersive collective problem-solving virtual reality (CPSVR). With Nexus providing a central collective intelligence hub for an organisation to collectively solve problems and build solutions, our clients experience improved transformation outcomes, superior change readiness, lightning-fast adaptability, and bolstered workforce resilience. Nexus is the first dedicated platform for Collective Intelligence application in enterprise and business transformation context.

### SUMMARY OF THE INVENTION

According to a first aspect of the invention there is provided a computer based method for organising big-data and extracting workstream parameters to expedite digital transformations, employing analytics to prompt, promote and predict better answers to complex challenges from cognitively diverse communities thus mitigating digital programme transformation risks using crowds of human-centred thinking, total knowledge sourcing, personalised skills enhancement, augmented problem analysis and immersive team solutioning that is channelled into a group consensus for better decision making, comprising:
a cloud based hosting and analytical AI platform;
connecting users and users operating programs, including internal and external knowledge systems, programme applications and collaboration devices via secure means to the platform;
authenticating users and workstreams;
parsing structured and unstructured data from the users operating programs;
extracting from the users operating programs sequence, volume and intensity of challenges, problems and tasks to determine optimum solutioning profiles;
performing analytics to prompt, promote and prescribe solutioning and risk mitigating actions and determining risk profile;
clustering and sequencing challenges to be solved relative to defined risk profile solution themes, previously successful solution attempts from across the crowd or community and severity of risk relative to impact of a failed solution on transformation value objectives;
compiling and presenting metric and graphical representations of the solutioning and problem solving landscape to mitigate risk; and
determining best approaches to restructuring programme workstreams, team structures, task prioritisation and benefit realisation tracking.

According to a second aspect of the invention there is provided a computer based method for organising big-data and extracting workstream parameters to expedite digital transformations, which method employs analytics solution that predicts and mitigates digital programme transformation risks using human-centred interventions around skills, team composition, leadership, communication and collaboration, comprising:
providing a cloud based hosting and analytical AI platform;
   connecting users and users operating programs via secure means to the platform;
   authenticating users and workstreams;
parsing structured and unstructured data from the users operating programs;
   extracting from the users operating programs sequence, volume and intensity of tasks to determine optimum fulfilment profiles;
   performing analytics to prescribe risk mitigating actions and determining risk profile;
clustering and sequencing tasks relative to defined risk profile;
   predicting gaps and flagging emerging risks continuously during the lifecycle of the programs;
compiling and presenting metric and graphical representations to mitigate risk; and
presenting restructured workstreams.

Preferable features of any of the above methods are noted below:

Preferably, the data offered is in the form of documents, text, images, video, media files, metadata etc.

Preferably, the parsing of the data extracts metadata such as subject matter, topics, elements; and tags with keywords, location and codes of inter-connections.

Preferably, the clustering is arranged with filters offered from the metadata and selectable by a user.

Preferably, further comparing and quantifying a value of compatibility of said data or data subsections with the users' operating program sequence.

Preferably, the parsing comprises data from two or more sources.

Preferably, the presenting comprises a combination of high quantifying a value of subsections from multiples data sources.

Preferably, the methods are for use in virtual environments, in online virtual worlds or metaverse.

According to a third aspect of the invention there is provided a system for organising big-data and extracting workstream parameters to expedite digital transformations, which method employs analytics solution that predicts and mitigates digital programme transformation risks using human-centred interventions around skills, team composition, leadership, communication and collaboration, comprising the details of any of the above mentioned methods.

According to a fourth aspect of the invention there is provided a non-transitory computer-readable storage medium having stored thereon computer-readable code, which, when executed by computing apparatus, causes the computing apparatus to perform the above mentioned methods.

### BRIEF DESCRIPTION OF THE DRAWINGS

The invention will now be described, by way of non-limiting example, with reference to the accompanying drawings, in which:

FIG. 1 depicts a high level diagram of a system in accordance with the invention;

FIG. 2 is an alternative depiction of the system in accordance with the invention;

FIG. 3 shows an illustration of the invention subsystems: Ingest, Supplement; Cluster, Predict and Output;

FIG. 4 shows an illustration of the User Journey as defined by the invention;

FIG. 5 shows a data flow diagram of the architecture in accordance with the invention;

FIG. 6 shows an illustration of the two solutions proposed by the invention:

FIGS. 7 and 8 show illustrations of the journey to intelligent digital delivery proposed by the invention;

FIGS. 9 to 13 depict illustrations on how the invention presents tags, metadata, and collaborative sections on parsed data; and

FIG. 14 depict illustration of the system and output in a virtual environment or metaverse.

### DESCRIPTION OF THE INVENTION

This invention relates to computer based system and method for organising big-data and extracting workstream parameters to expedite digital transformations, which system and method employs analytics to prompt, promote and predict better answers to complex challenges from cognitively diverse communities thus mitigating digital programme transformation risks using crowds of human-centred thinking, total knowledge sourcing, personalised skills enhancement, augmented problem analysis and immersive team solutioning that's channelled into a group consensus for better decision making.

As noted above. the key to solving problems and building solutions is connected knowledge. Knowledge of the problem, knowledge of potential solutions, knowledge of the latest expertise and management science that applies to the issues, knowledge of what has or hasn't worked before, knowledge of where to look, knowledge of who to ask, knowledge of how to ideate, knowledge of how to deliver. Unfortunately, organisations are brimming full of knowledge, human experience and unawakened potential—but this knowledge is often hard to access at the point of need. Knowledge is lost in silos, knowledge is not connected up across programs, knowledge is out-of-date or unchallenged by the latest thinking.

This is because they are able to leverage and build the collective intelligence of the group, to come up with faster, better solutions than their counterparts.

It is this collective intelligence, and the ability to translate connected thinking into action, that delivers superior value. But how do you build collective intelligence?

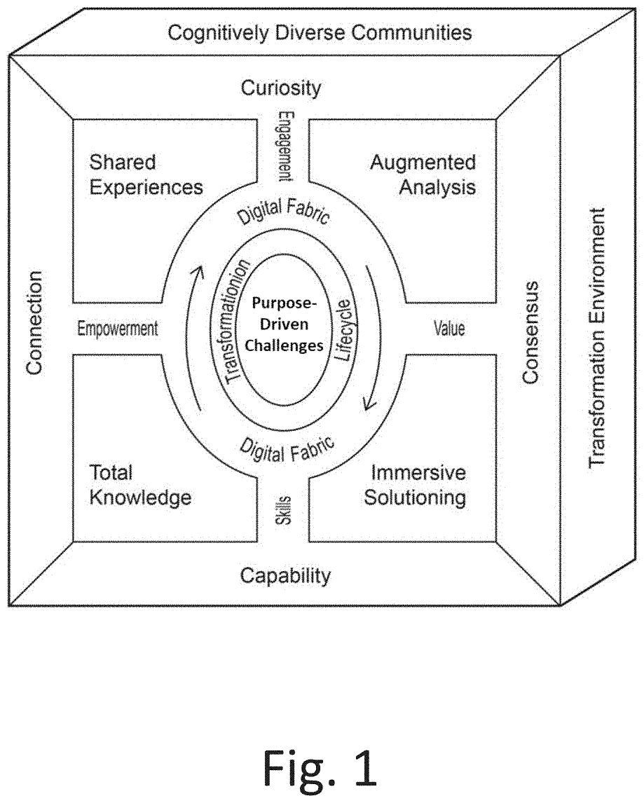

Referring to FIG. 1, there is shown high level diagram of a system in accordance with the invention.

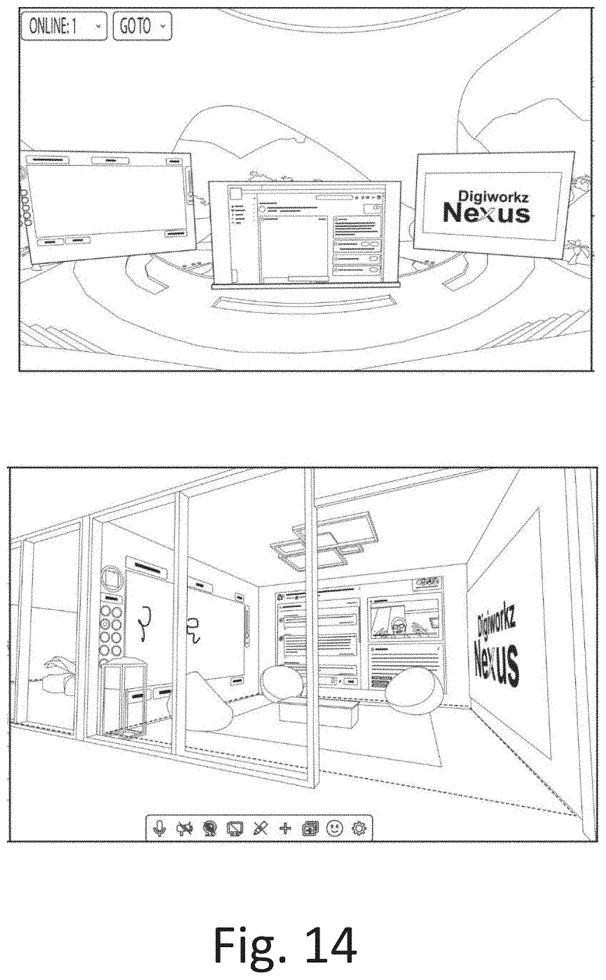

Leveraging Collective Intelligence: Our collective intelligence method and system, named Nexus™, leverages collective intelligence, and drive superior value from transformation programs. Powered by artificial intelligence, and housed in the metaverse, as shown in FIG. 14, Nexus™ connects people across an organisation to the latest knowledge, ideas and tools that can help them to collectively solve problems—including our client community driven, ever expanding graph of transformation problems that have been posted. We call the challenges and the resultant solutions that are shaped on our technology nodes. These nodes are surfaced to clients to leverage the past experiences and outcomes experienced by other clients that encountered similar challenges and overcame them successful. This ability to interrogate, aggregate and prescribe insights to problems is performed by our AI brain in Nexus called Noda™.

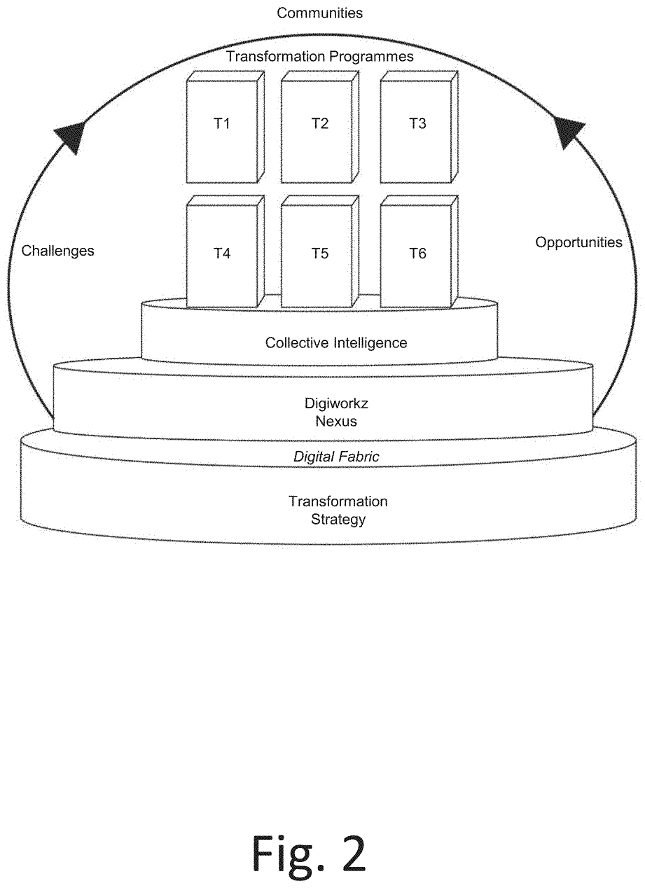

Referring to FIG. 2, the inventions provides the central environment for all transformation-related problem-solving, knowledge-sharing and solution-building. It also provides individual users with a tailored multi-sensory experience, a sort of “Netflix of Collective Intelligence”. Nexus is the first dedicated platform for Collective Intelligence application in enterprise and business transformation context.

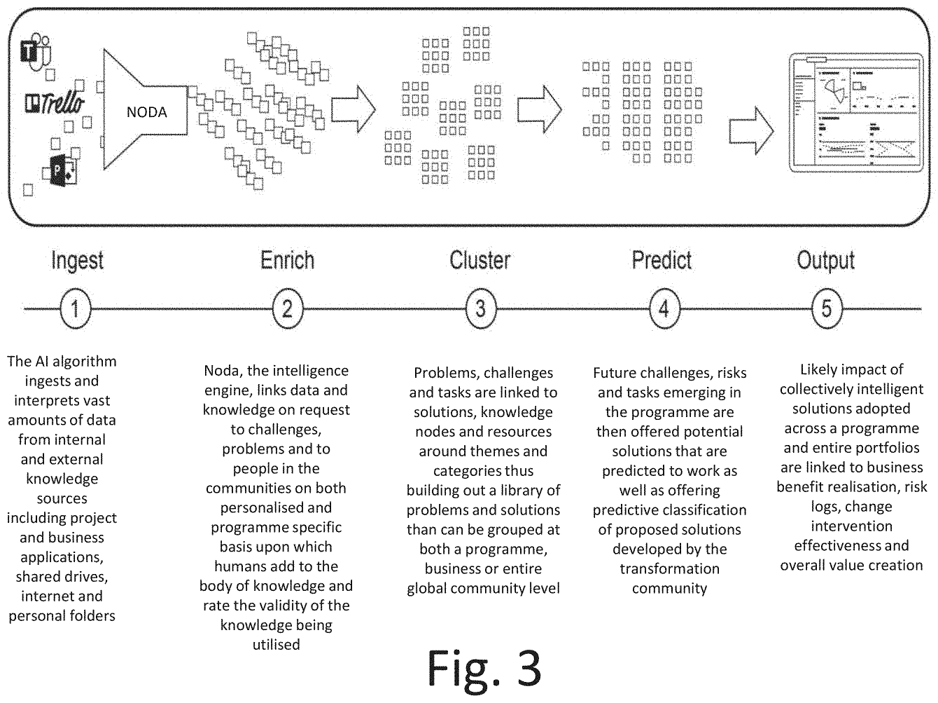

FIG. 3 shows an illustration of the invention's AI Engine, Deep learning at the core:
Ingest—The AI algorithm ingests vast amounts of structured and unstructured data from the project and business systems. The AI algorithm ingests and interprets vast amounts of data from internal and external knowledge sources including project and business applications, shared drives, internet and personal folders.
Enrich—Supplements and enriches project management data with additional data points for skills, mindsets, experiences, capacity and motivation of proposed team resources. Noda, the intelligence engine, links so data and knowledge on request to challenges, problems and to people in the communities on both personalised and programme specific basis upon which humans add to the body of knowledge and rate the validity of the knowledge being utilised.
Cluster—Clusters tasks with required capabilities and sequencing relative to risk profile. Problems, challenges and tasks are linked to solutions, knowledge nodes and resources around themes and categories thus building out a library of problems and solutions than can be grouped at both a programme, business or entire global community level.
Predict—Predicts the existing gaps and flags emerging risks as the programme lifecycle unfolds. Future challenges, risks and tasks emerging in the programme are then offered potential solutions that are predicted to work as well as offering predictive classification of proposed solutions developed by the transformation community.
Output—Prompts insights from across all workstreams, projects and portfolio to mitigate risk. Likely impact of collectively intelligent solutions adopted across a programme and entire portfolios are linked to business benefit realisation, risk logs, change intervention effectiveness and overall value creation.

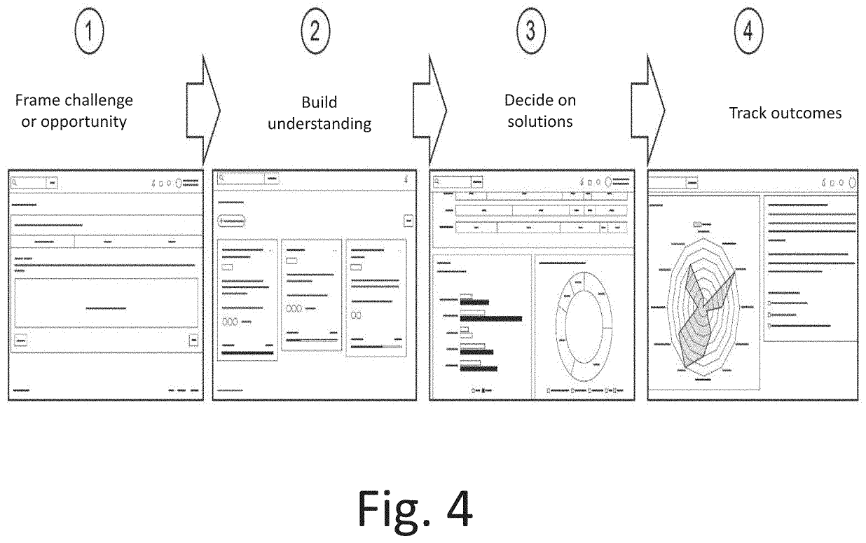

FIG. 4 shows an illustration of the User Journey as defined by the invention:
1. Upload project documents into the system
2. Look at the snapshot of how other projects are performing
3. Analyse and understand why particular projects are failing
4. Make an intervention and monitor the impacted areas

The invention works by integrating all programme tools and technologies to create a master datahub that is continuously analysed in real-time using Artificial Intelligence, (AI), which datahub can then be recalled and become a ‘virtual member’ of a team solving a problem they are facing.

Thus the invention discloses a computer based method for organising big-data and extracting workstream parameters to expedite digital transformations, employing analytics to prompt, promote and predict better answers to complex challenges from cognitively diverse communities thus mitigating digital programme transformation risks using crowds of human-centred thinking, total knowledge sourcing, personalised skills enhancement, augmented problem analysis and immersive team solutioning that is channelled into a group consensus for better decision making, comprising:
a cloud based hosting and analytical AI platform;
connecting users and users operating programs, including internal and external knowledge systems, programme applications and collaboration devices via secure means to the platform;
authenticating users and workstreams;
parsing structured and unstructured data from the users operating programs;
extracting from the users operating programs sequence, volume and intensity of challenges, problems and tasks to determine optimum solutioning profiles;
performing analytics to prompt, promote and prescribe solutioning and risk mitigating actions and determining risk profile;
clustering and sequencing challenges to be solved relative to defined risk profile solution themes, previously successful solution attempts from across the crowd or community and severity of risk relative to impact of a failed solution on transformation value objectives;
compiling and presenting metric and graphical representations of the solutioning and problem solving landscape to mitigate risk; and
determining best approaches to restructuring programme workstreams, team structures, task prioritisation and benefit realisation tracking.

Alternatively, the invention discloses a computer based system and method for organising big-data and extracting workstream parameters to expedite digital transformations, which method employs analytics solution that predicts and mitigates digital programme transformation risks using human-centred interventions around skills, team composition, leadership, communication and collaboration, comprising: providing a cloud based hosting and analytical AI platform;

connecting users and users operating programs via secure means to the platform;
authenticating users and workstreams; parsing structured and unstructured data from the users operating programs; extracting from the users operating programs sequence, volume and intensity of tasks to determine optimum fulfilment profiles; performing analytics to prescribe risk mitigating actions and determining risk profile; clustering and sequencing tasks relative to defined risk profile; predicting gaps and flagging emerging risks continuously during the lifecycle of the programs; compiling and presenting metric and graphical representations to mitigate risk; and presenting restructured workstreams.

Preferably, the data offered is in the form of documents, text, images, video, media files, metadata etc. The parsing of the data extracts metadata such as subject matter, topics, elements; and tags with keywords, location and codes of inter-connections.

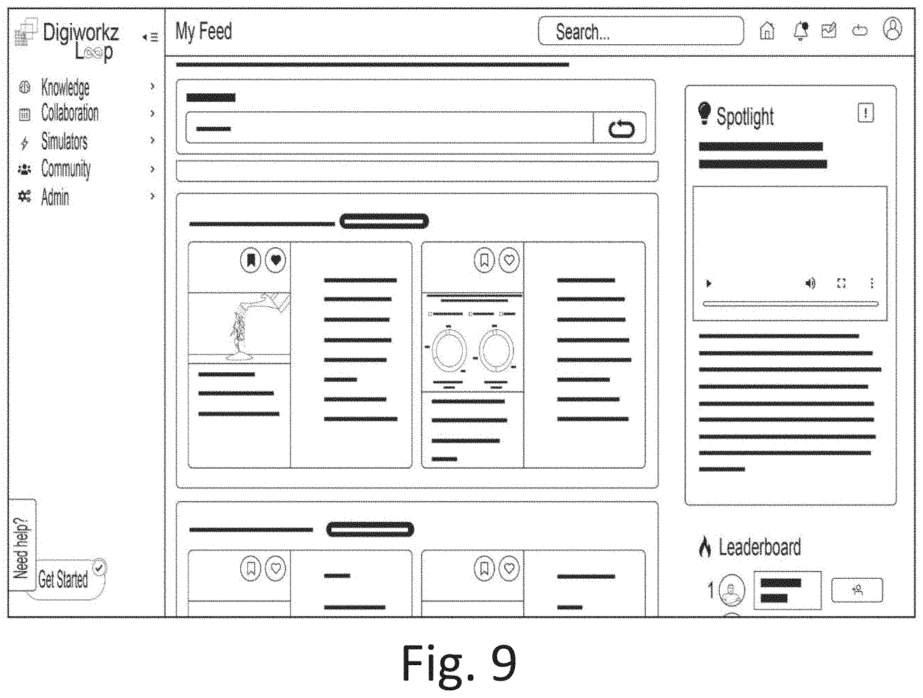

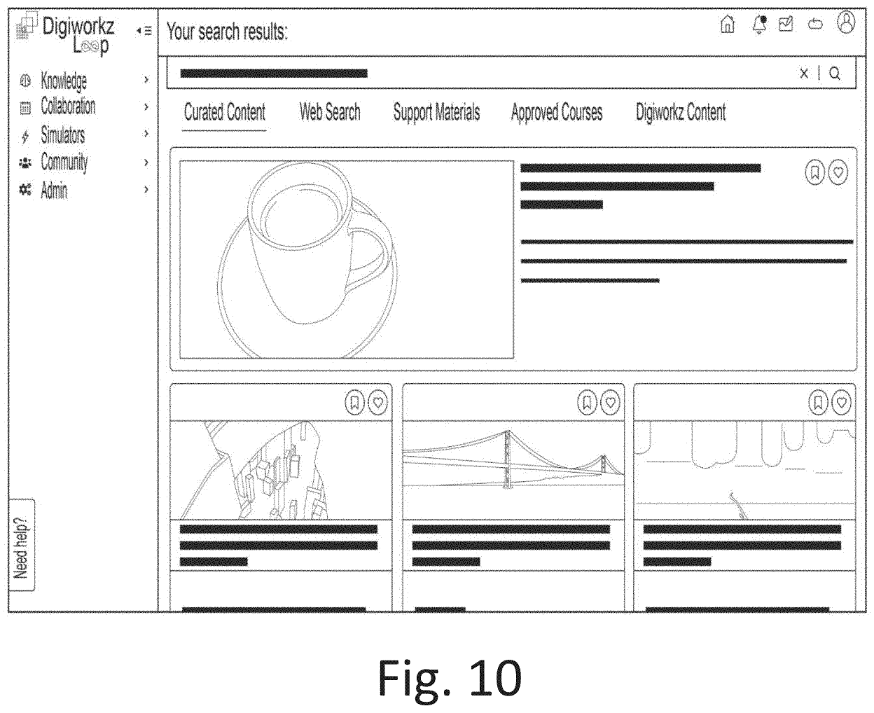

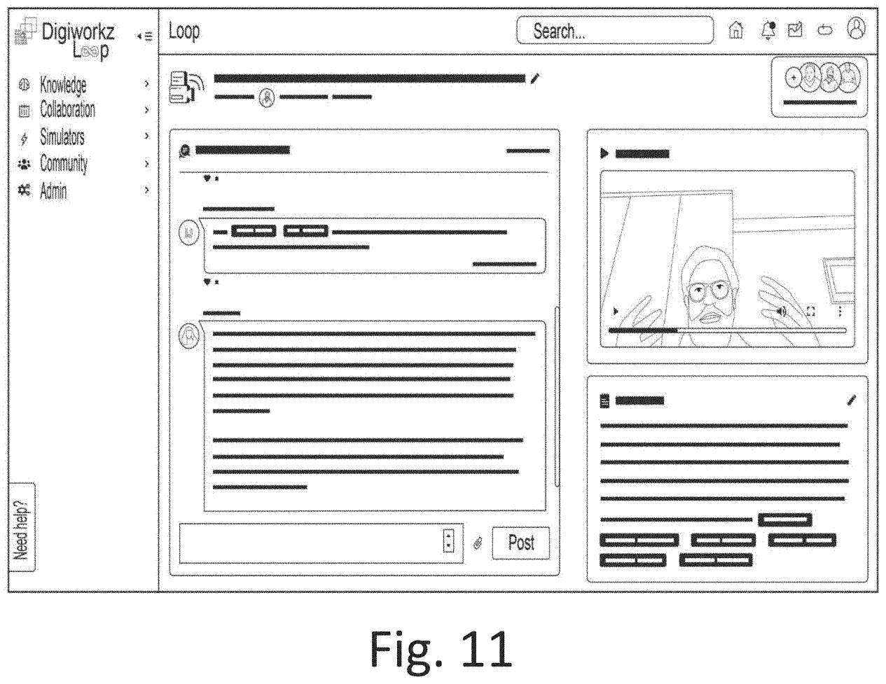

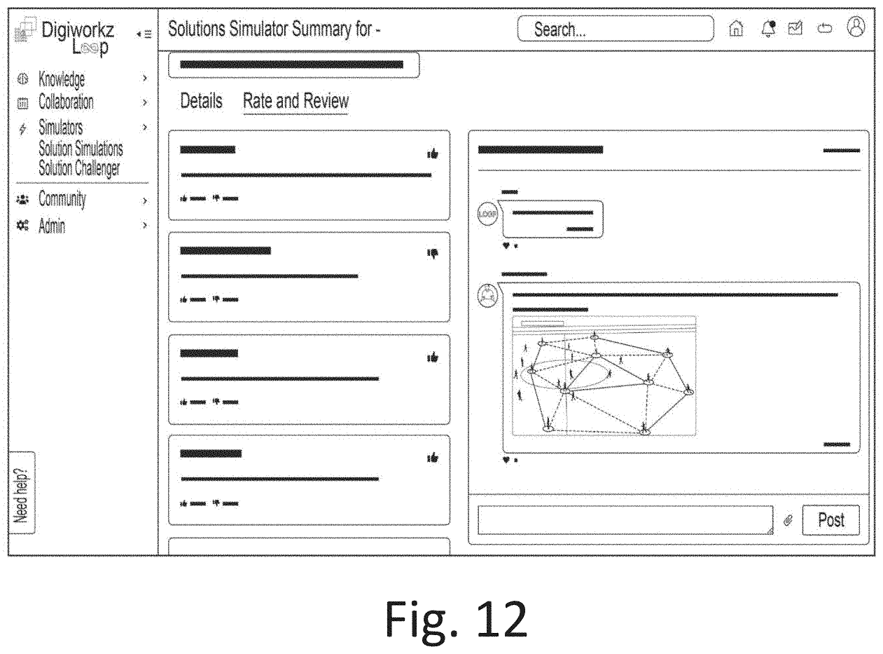

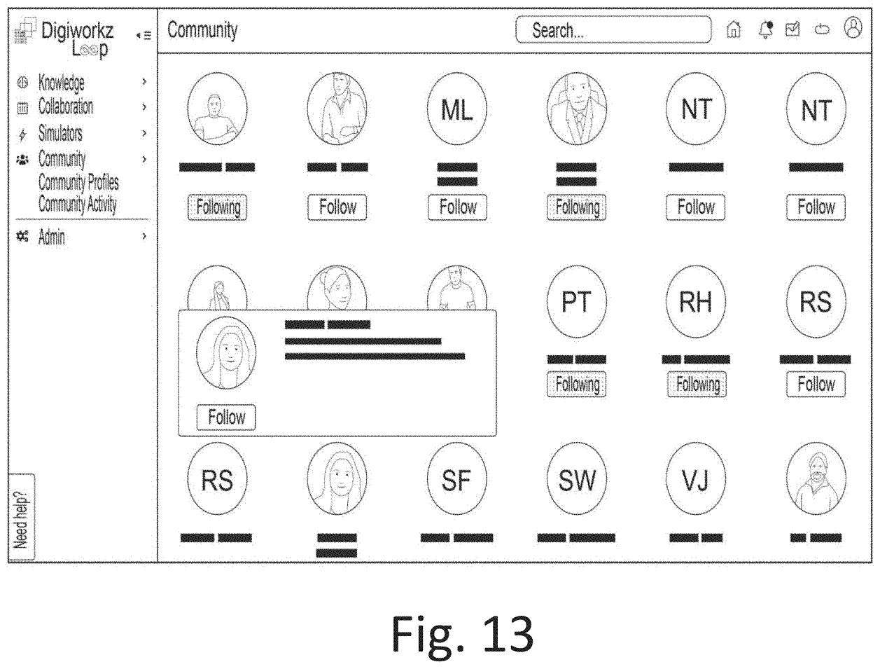

The clustering may be arranged with filters offered from the metadata and selectable by a user. Further comparing and quantifying a value of compatibility of said data or data subsections with the users' operating program sequence. The parsing may comprise data from two or more sources. The presenting comprises a combination of high quantifying a value of subsections from multiples data sources, as shown e.g. in FIGS. 9 to 13.

The invention may be for use in virtual environments, in online virtual worlds or metaverse as shown in FIG. 14.

A third aspect of the invention provides a system for organising big-data and extracting workstream parameters to expedite digital transformations, which method employs analytics solution that predicts and mitigates digital programme transformation risks using human-centred interventions around skills, team composition, leadership, communication and collaboration, comprising the details of any of the above mentioned methods.

A fourth aspect of the invention provides a non-transitory computer-readable storage medium having stored thereon computer-readable code, which, when executed by computing apparatus, causes the computing apparatus to perform any of the above mentioned methods.

As an example, referring to FIG. 3, in section 1 of the Figure, structured and unstructured data, relating e.g. to the assembly of DIY furniture is fed into the AI algorithm. The data may be an assembly manual with text and diagrams, other sources of data such as pictures and videos etc. Further seemingly unrelated data from other sources and content may be included, e.g. data on colour combinations in a room with and without furniture, or how to use an electric screwdriver, or data on wood density, plywood, MDF, fibreboards, or data on support beam structure, lift details and capacity etc.

In section 2 the data may be ‘enriched’ by analysing and extracting parameters; elements and metadata from the ingested data. Such parameters might be, dimensions, wights, colour, number of screws, work hours required for assembly.

From the other data it could be colour combinations; power of the screwdriver, battery life; details on the board materials' information of weight support of the beam and lift etc.

In section 3, sub data, elements and metadata might be grouped and clustered. There might be interconnections and webbing between the different data subsections.

In section 4, the invention predicts, e.g. that a room data with certain colours might require furniture with presented colour, weight, dimension, and quantified values on ease of assembly. Information on the weight e.g. can be flagged in relation to support beams of a room, or of the lift it will be transported.

In section 5, graphical and quantified numerical output are presented, with sections of quantifiable matching or compatibility, of what would be a more suitable approach, product and proposal.

Filters and variable inputs may be selected by a user, which in turn changes the output parameters and proposals presented.

Alternative compatibilities may be shown, emphasising and showing different level of compatibility on different matching requirements. E.g. as shown is section 4 of FIG. 4. Thus offering the user a different approach, which might present a better overall solution to the previous output, concentrating e.g. on high matching value of a parameter.

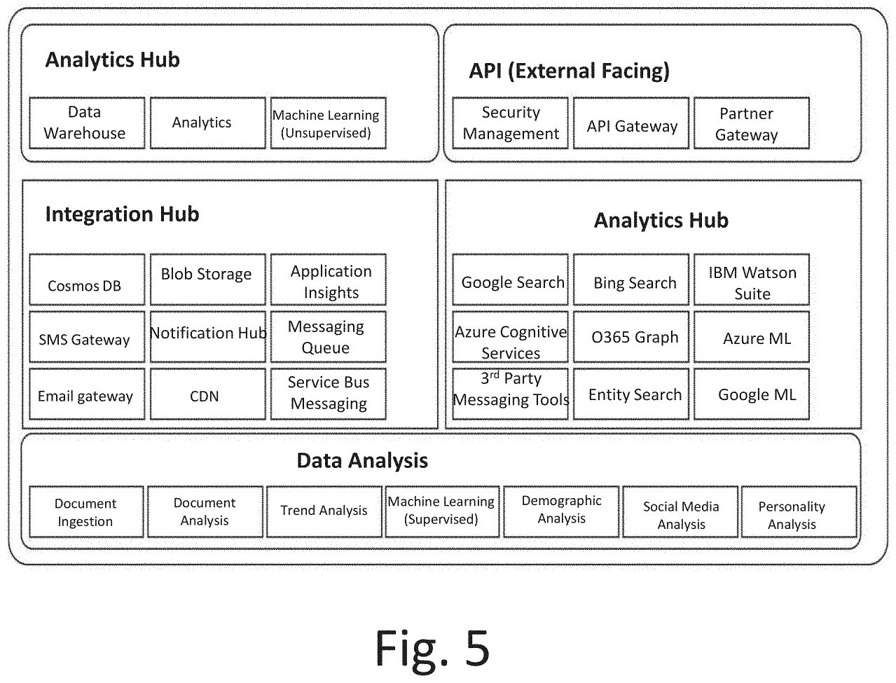

FIG. 5 shows a data flow diagram of the platform in accordance with the invention. The platform is based on a Micro-Services architecture that allows for a resilient and scalable approach to providing services to clients. Most importantly it allows the system to evolve quickly to provide enhancements and future services at speed to clients and respond to market changes.

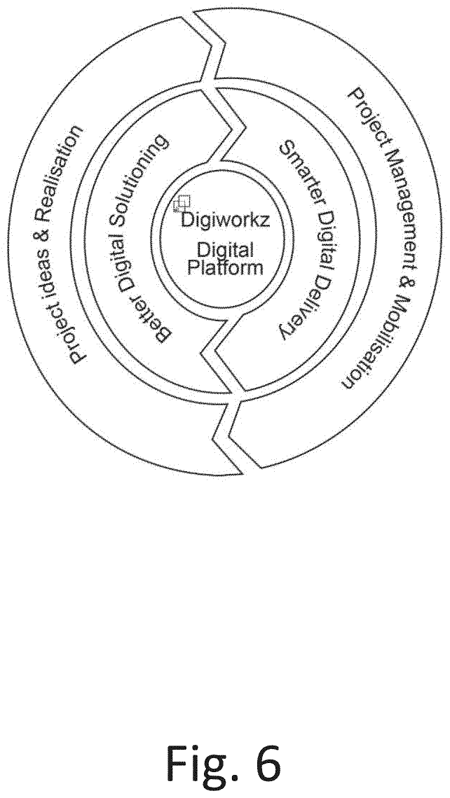

FIG. 6 shows an illustration of the two solutions proposed by the invention:
Module A— Left side
   Challenge conventional approaches to problem-solving and encourage independent thinking
   Breakdown organisational silos by harnessing the power of collective intelligence
   Design detail story boards of proposed solutions that are stress tested with the wider community before sign off
Module B— Right side
   Identify, understand and predict project risks related to people skills before they happen
   Design strategies to mitigate those risks and ensure successful digital transformation
   Create plans that develop human capabilities and mindset to match project requirements

Module B is a 360 human risk forecasting & digital project optimisation platform
Defines strategic digital initiatives more thoroughly.
Identifies specific human requirements and prompts capability led interventions.
Looks across the line of all projects and portfolios to optimise capability.
Looks digital transformation risk through the lens of the humans designing, running, and adopting the digital solutions.
Uses AI to assimilate risks, flag issues and promote mitigations.

The invention aims to replace human propensity to miss data insights with an automatic sensing and signalling of what is going on and uses analytics to prescribe risk mitigating actions.

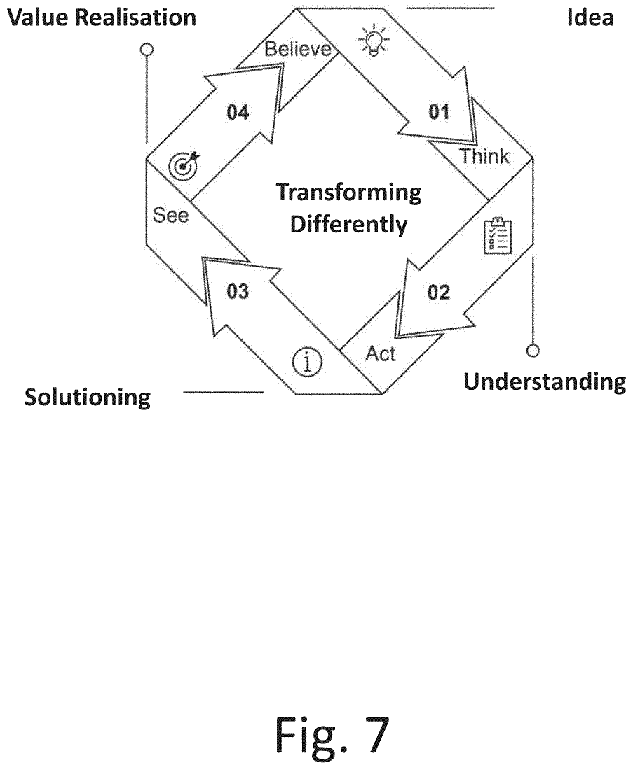

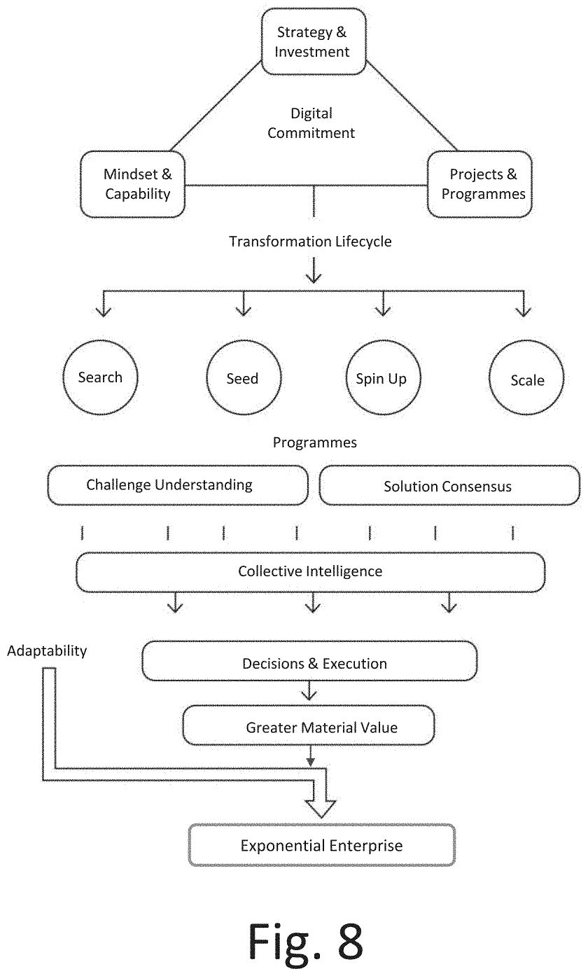

FIGS. 7 and 8 show illustrations of the journey to intelligent digital delivery proposed by the invention:
Project Idea—Improve mindsets on how digital problems should be solved more effectively by harnessing the power of team intelligence and effective collaboration.
Project Mobilisation—Interpret the scope and requirements of digital projects, link those to human factors & apply to monitoring and controls through the lifecycle of the project.
Project Management—Tools and insights that provide real-time assistance and intervention on areas of prioritisation.
Project Realisation—Directly link the input activities and outputs of your digital transformation efforts to business outcome and value creation. As a result, organisations will begin to put a measure and quantification on human capital value.

In further detail the invention can be presented as two modules:

Module 1:
Users determine challenge areas of focus based on programmes, projects or communities which the platform groups people around.
Platform fosters users to post their challenges in order to seek support, guidance and the collective intelligence of the community.
Collectives of people discuss ideas, share content in the forms or whiteboards and content (articles, reports, previous work etc).
   Side note—explore and engage with content to gain knowledge and up skill, powered by an AI recommendations providing curated content to you based on your interest and activities to support your challenges/discussions.
Discussion is created amongst the collective and AI engine reviews the discussion and content shared to track the flow of the conversation.
Provides recommendations and suggestions of content and ideas for the discussion as well as connect relevant members of the community to the discussion who should or would be good to contribute to the discussion based on expertise, interest and past experience.
AI recommends next steps for the challenge discussion primarily when to move to a Solution Simulator or suggested additional points of discussion
Simulators generated. In Simulator users determine the solution template they want to use to support them in generating their solution.
Users anonymously answer questions on the template.
Users anonymously rate others answers.
AI engine analyses questions, ratings and supporting content from Loops, whiteboards and content to produce output report and recommendations for solution
Group determine solution and product initiative(s) to deliver.
Create solution planning template which can be fed into project plan or into Module 2.

Module 2
Ideas and initiative fed into project plan/project programme documentation OR initiative directly into platform.
Project docs/initiatives read by platform.
Initiatives broken down into tasks/programme of activities and required skills to complete.
AI analyses initiative, project actions and combines this with team signals (capability, work types, capacity, sentiment) to produce tracking and any potential risks and costs to delivery.
Project/programme managers track and take action based on signals.

A further Support or Management Module provides the following:
Management calculating the effectiveness of Collective Intelligence.
Dashboard of metrics to track use of collective intelligence.
AI engine shows level of collective discussion across different groups shows how the recommendations it is creating is effective cross group collaboration and ensuring the most effective people are contributing to different initiatives.
Provides a collective intelligence score based on contributions, use of AI recommendations and solutions generated. If module two is purchased this also measure initiative success.
Provides recommendations on how to develop collective intelligence score more effectively.

FIGS. 9 to 13 depict illustrations on how the invention presents tags, metadata, and collaborative sections on parsed data.

Deployment Example:

Global Bank: At the onset of the Covid pandemic a global organisation with 90,000 employees faced a series of business continuity and customer critical changes. This required real-time transformation to working practices, IT infrastructure, digital solutions, real-estate usage and workforce optimisation.

Central to the effectiveness of the transformation response was the ability for disparate teams, that were now forcibly working remotely, to:
Mobilise as one team with a shared purpose—business continuity underpinned by workforce safety and wellbeing
Flush through all the challenges, considerations, problems, decision points and critical dependencies
Rapidly understand, explore and contextualise these problems through multiple lenses such as business divisions, differing geographies, disparate local Covid rules and regulations and diverse operating models,
Propose solutions, reach consensus and mobilise ideas into action Track and evaluate impact

The system enabled the client to:
Rapidly form a single response community aligned around a shared purpose but representative of different divisions, silos, skills, capabilities and resources.
Harness the cognitive diversity of this group—a critical predictor of ability to build collective intelligence—and provide a transformation environment for them to become connected to each other.
Utilised content and communication to spark curiosity for thinking differently about problems and challenges that were emerging and how to solve them
Hooked up internal knowledge and sources with AI powered search amplification of all internet content and academic research and aligned these with the challenges presented.
Supplemented individual and team gaps in knowledge with on-line learning and skills development programmes.
Immersed solutioning groups in consensus building collaboration environments to help shape and lockdown solutions using the metaverse for a campus based virtual reality environment that facilitated collaboration and decision making.
Utilised the power and intelligence of the full community to rate and refine ideas and solutions and harnessed machine learning algorithms to predict strength of engagement and validation of likely success.
Tracked the themes, interests, engagement and confidence of the community over time an developed an index measure illustrating the expanding nature of collective intelligence across the community.

As a result the bank cited far greater positive feedback from members of community about the ability of Nexus to provide a positive transformation experience, deliver better results and more positively impact the critical outcomes of the organisation.

It will be appreciated that the above described embodiments are purely illustrative and are not limiting on the scope of the invention. Other variations and modifications will be apparent to persons skilled in the art upon reading the present application.

Moreover, the disclosure of the present application should be understood to include any novel features or any novel combination of features either explicitly or implicitly disclosed herein or any generalization thereof and during the prosecution of the present application or of any application derived therefrom, new claims may be formulated to cover any such features and/or combination of such features.

1. A computer based method for organising big-data and extracting workstream parameters to expedite digital transformations, employing analytics to prompt, promote and predict better answers to complex challenges from cognitively diverse communities thus mitigating digital programme transformation risks using crowds of human-centred thinking, total knowledge sourcing, personalised skills enhancement, augmented problem analysis and immersive team solutioning that is channelled into a group consensus for better decision making, comprising:
a cloud based hosting and analytical AI platform;
connecting users and users operating programs, including internal and external knowledge systems, programme applications and collaboration devices via secure means to the platform;
authenticating users and workstreams;
parsing structured and unstructured data from the users operating programs;
extracting from the users operating programs sequence, volume and intensity of challenges, problems and tasks to determine optimum solutioning profiles;
performing analytics to prompt, promote and prescribe solutioning and risk mitigating actions and determining risk profile;
clustering and sequencing challenges to be solved relative to defined risk profile solution themes, previously successful solution attempts from across the crowd or community and severity of risk relative to impact of a failed solution on transformation value objectives;
compiling and presenting metric and graphical representations of the solutioning and problem solving landscape to mitigate risk; and
determining best approaches to restructuring programme workstreams, team structures, task prioritisation and benefit realisation tracking.

2. A computer based method for organising big-data and extracting workstream parameters to expedite digital transformations, which method employs analytics solution that predicts and mitigates digital programme transformation risks using human-centred interventions around skills, team composition, leadership, communication and collaboration, comprising:
providing a cloud based hosting and analytical AI platform;
connecting users and users operating programs via secure means to the platform;
authenticating users and workstreams;
parsing structured and unstructured data from the users operating programs;
extracting from the users operating programs sequence, volume and intensity of tasks to determine optimum fulfilment profiles;
performing analytics to prescribe risk mitigating actions and determining risk profile;
clustering and sequencing tasks relative to defined risk profile;
predicting gaps and flagging emerging risks continuously during the lifecycle of the programs;
compiling and presenting metric and graphical representations to mitigate risk; and
presenting restructured workstreams.

3. A method according to claim 1, wherein the data offered is in the form of documents, text, images, video, media files, metadata etc.

4. A method according to claim 3, wherein the parsing of the data extracts metadata such as subject matter, topics, elements; and tags with keywords, location and codes of inter-connections.

5. A method according to claim 4, wherein the clustering is arranged with filters offered from the metadata and selectable by a user.

6. A method according to claim 1, further comparing and quantifying a value of compatibility of said data or data subsections with the users' operating program sequence.

7. A method according to claim 6, wherein the parsing comprises data from two or more sources.

8. A method according to claim 1, wherein the presenting comprises a combination of high quantifying a value of subsections from multiples data sources.

9. A method according to claim 1, wherein the method is for use in virtual environments, in online virtual worlds or metaverse.

10. A system for organising big-data and extracting workstream parameters to expedite digital transformations, which method employs analytics solution that predicts and mitigates digital programme transformation risks using human-centred interventions around skills, team composition, leadership, communication and collaboration, performing the method of claim 1.

11. A non-transitory computer-readable storage medium having stored thereon computer-readable code, which, when executed by computing apparatus, causes the computing apparatus to perform the method of claim 1.
